(19) United States
(12) Patent Application Publication
(10) Pub. No.: US 2012/0166796 A1
(43) Pub. Date: Jun. 28, 2012

(54) SYSTEM AND METHOD OF PROVISIONING OR MANAGING DEVICE CERTIFICATES IN A COMMUNICATION NETWORK

(75) Inventors: ANTHONY R. METKE, NAPERVILLE, IL (US); ERWIN HIMAWAN, CHICAGO, IL (US); MARK D. SEABORN, ALGONQUIN, IL (US); SHANTHI E. THOMAS, CARPENTERSVILLE, IL (US)

(73) Assignee: MOTOROLA SOLUTIONS, INC., Schaumburg, IL (US)

(21) Appl. No.: 12/980,250

(22) Filed: Dec. 28, 2010

(51) Int. Cl. H04L 9/00

(52) U.S. Cl. 713/158; 713/156

(57) ABSTRACT

A certificate manager transmits a certificate service advertisement to a plurality of certificate clients. The certificate service advertisement identifies the certificate manager and includes segregation data. The segregation data indicates a set of services offered or a set of clients for which the certificate manager offers service. Responsive to the transmitting of the certificate service advertisement, the certificate manager receives a certificate service request from at least one certificate client of the plurality of certificate clients. The certificate manager verifies that the at least one certificate client is associated with the set of clients for which the certificate manager offers service, and the certificate manager fulfills the certificate service request.

### TECHNICAL FIELD

The present disclosure relates generally to communication systems and in particular to a system and method of provisioning or managing device certificates in a communication network.

### BACKGROUND

Secure and efficient real-time communication with minimal latency is a critical requirement for public safety organizations and first responders. As broadband cellular networks have improved, public safety organizations and first responders have begun to adopt and rely on broadband cellular networks as complementary solutions to existing narrowband networks. In particular, 3rd Generation Partnership Project (3GPP) Long Term Evolution (LTE), as described in the 3GPP 36-series documents for instance, and any subsequent revisions, is emerging as the broadband solution of choice for public safety applications. In a typical scenario, legacy narrowband networks are used for voice communication while low latency, high-throughput LTE broadband networks are used to enable data-intensive multimedia communication such as video streaming and other multimedia services.

Moreover, LTE networks enable efficient data-intensive Multimedia Broadcast/Multicast Service (MBMS) over wireless networks to any number of mobile devices. Thus, mission critical images, video, or other multimedia streams can be simultaneously delivered to a plurality of emergency responders, officials, or other agencies and individuals requiring such information.

However, these improvements in broadband cellular networks have resulted in a substantial increase in the amount of users and data that is transmitted over wireless networks that needs to be secured.

A common method for implementing network security is with the use of a public key infrastructure (PKI). PKI utilizes asymmetric key cryptography. With public key cryptography, a user's private key is used to create a signature and the user's associated public key is used to verify the signature. A private key and the associated public key are collectively referred to as the user's key pair. In PKI, the user's public key is bound to the user's identity by a digital certificate that is signed by a trusted third-party, known as a certificate authority (CA). It is well known that digital certificates can be issued to either users (people) or devices. Whether the certificate is issued to a user or a device, the entity for which a certificate is being issued is known at the certificate subject. A user's request for a certificate is typically handled by a registration authority (RA), which verifies the user's identity and forwards the certificate request to the CA; although in some systems it is possible for a user to send the request directly to a CA.

PKI providers generally provide web-based interfaces, requiring human intervention, to work with their RAs and CAs. Currently, provisioning certificates on devices requires either manual human effort or factory provision. The manual approach requires that either a trusted device sponsor logs on to the device and manually forces the device to request a certificate, or the device sponsor requests a certificate and corresponding private key on behalf of the device; and after receiving the certificate and private key, the device sponsor manually installs them on the device. Such methods can be time consuming and error prone. Also, in the case where the device sponsor requests both the private key and certificate, it is necessary to transfers both the private key and the associated certificate to a device. Such a method is known to be less secure than allowing the device to generate its own key pair and request an associated certificate, as it is necessary to secure the private key during this transmission.

The factory provisioning methods do not provide sufficient capabilities for many use cases. That is, they mainly support manufacturer issued certificates, rather than owner/operator issued certificates. Factory provisioning of certificates typically transfers both the private key and the associated certificate to a device. As mentioned above, such a method is known to be less secure than allowing the device to generate its own key pair and request an associated certificate. Further, because PKI providers typically expect a human user to manually request certificates via a web interface, there exist no efficient methods to notify devices as to when to perform certificate management, where to forward certificate management messages, or which options or protocols are supported when performing certificate management.

Accordingly, there is a need for a system and method of provisioning or managing device certificates in a communication network.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 illustrates a communication system in accordance with some embodiments of the present disclosure.

FIG. 2 is a logical flowchart, from the perspective of a certificate manager, showing an illustrative method in a communication network for provisioning or managing device certificates in accordance with some embodiments of the present disclosure.

FIG. 3 is a logical flowchart, from the perspective of a certificate client, showing an illustrative method in a communication network for provisioning or managing device certificates in accordance with some embodiments of the present disclosure.

FIG. 4 illustrates a sequence diagram for provisioning or managing device certificates in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a system and method for provisioning or managing device certificates in a communication network. A certificate manager transmits a certificate service advertisement to a plurality of certificate clients. The certificate service advertisement identifies the certificate manager and includes segregation data. The segregation data indicates a set of services offered or a set of clients for which the certificate manager offers service. Responsive to the transmitting of the certificate service advertisement, the certificate manager receives a certificate service request from at least one certificate client of the plurality of certificate clients. The certificate manager verifies that the at least one certificate client is associated with the set of clients for which the certificate manager offers service and then fulfills the certificate service request.

In other embodiments, a certificate client listens to a plurality of certificate service advertisements that correspond to a plurality of certificate managers. Each of the plurality of certificate service advertisements includes segregation data. The certificate client identifies one certificate manager from the plurality of certificate managers, where the one certificate manager's certificate service advertisement includes segregation data that corresponds to the certificate client. Responsive to identifying the one certificate manager, the certificate client determines if certificate services are required, and when certificate services are required, the certificate client transmits a certificate service request to the one certificate manager. The certificate client receives a response for the certificate service request from the one certificate manager.

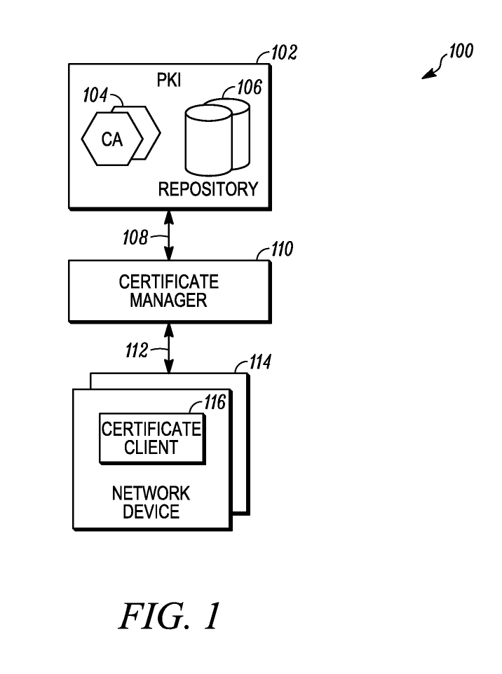

Referring now to the figures, FIG. 1 shows a communication system 100 capable of supporting PKI services for network devices operating within the system 100. The communication system 100 provides a general depiction of a physical implementation of various aspects of the present disclosure. The communication system 100 includes a PKI 102 including one or more CAs 104 and one or more repositories 106. The CAs 104 are trusted entities that are responsible for issuing digital certificates. As used herein, the terms “certificate” and “digital certificate” are used interchangeably. A certificate or digital certificate is defined as to a file signed by the CA, using the CA's private key, which contains a user or device's public key and related user/device identity information. Further, as used herein, the term “signed” or “signature” means performing a cryptographic operation on a block of data, resulting in a new block of data. The repositories 106 include a lightweight directory access protocol (LDAP) server for managing PKI information, as described, for example, in Internet Engineering Task Force (IETF) Request for Comments (RFC) 4510 published June 2006, and any subsequent revisions. The repositories 106 also include databases for storing certificate requests and keys, among others. The PKI may optionally contain one or more registration authorities (not shown in FIG. 1). The certificates generated by the PKI 102 are compliant with PKI standards, as described, for example, in Telecommunications Standardization Sector (ITU-T) PKI standard X.509 published August 2005, and any subsequent revisions.

The PKI 102 is coupled via a wired or wireless link 108 to a certificate manager 110. The certificate manager 110 is likewise coupled via a wired or wireless link 112 to one or more network devices 114. As shown, one or more of the network devices 114 includes a certificate client 116. The network devices 114 can include any combination of routers, access points, base stations, application servers, or other fixed or mobile elements of the communication network 100. In some embodiments, the network devices 114 also include any type of communication device such as radios, mobile phones, mobile data terminals, Personal Digital Assistants (PDAs), laptops, two-way radios, cell phones, etc. As described herein, the certificate manager 110 is equivalently referred to as a local registration authority (LRA). Generally, the certificate manager 110 handles certificate signing requests (CSRs) received from the certificate clients 116. For example, the certificate manager 110 forwards CSRs to the CA 104 to retrieve signed certificates and fulfill the certificate client's request.

Communication over the wired or wireless links 108, 112 is accomplished via any combination of well-known protocols. For example, communication over the wired or wireless links 108, 112 is accomplished via a Simple Certificate Enrollment Protocol (SCEP), as described, for example, in IETF Internet-Draft: draft-nourse-scep-21.txt published September 2010, and any subsequent revisions. Alternatively, communication over 108, 112 is accomplished via the Certificate Management Protocol (CMP), as described, for example, in IETF RFC 4210, or via Certificate Management Messages over Certificate Management Syntax (CMC), as described, for example, in IETF RFC 2797.

However, the implementation of the present teachings does not depend on the use of these protocols and standards but can be applied to various other protocols and standards as determined by the particular implementation of the communication system 100 (and corresponding radio access technology). In addition, only a limited number of network devices 114 and one certificate manager 110 are shown for simplicity of illustration. However, it should be understood that the present teachings extend to a system that includes additional such elements.

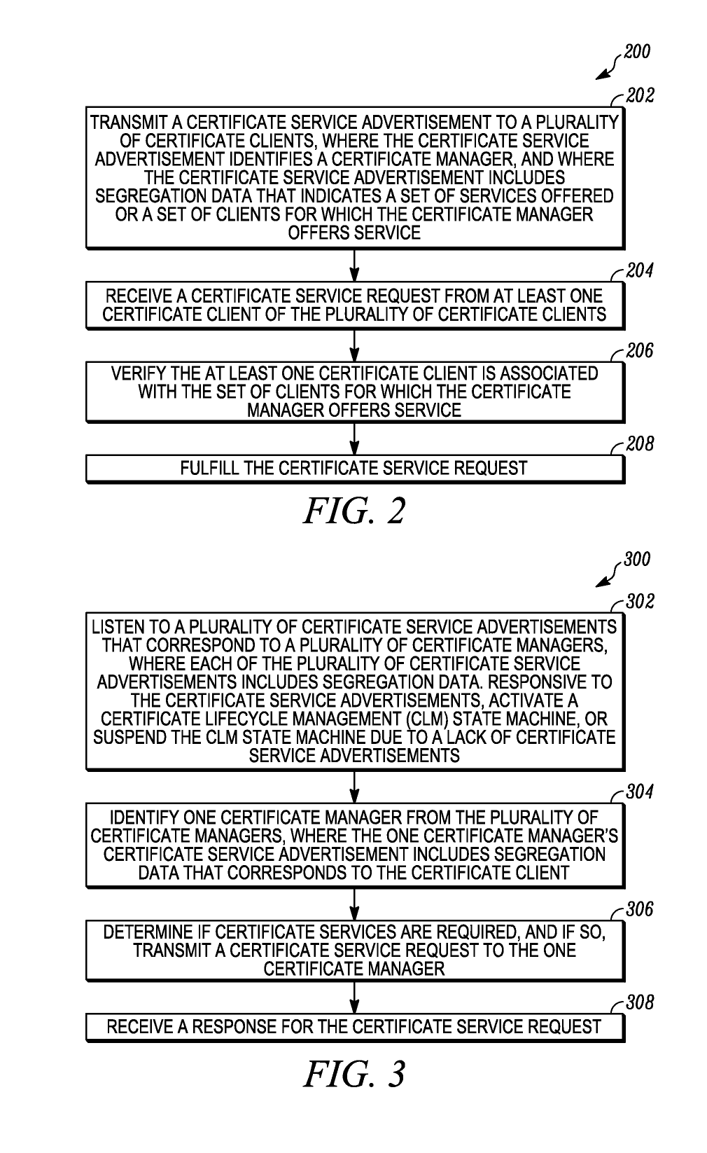

In general, components of the communication system 100 including the PKI 102, the certificate manager 110, and the network devices 114 are implemented using one or more memory devices, network interfaces, and processing devices that are operatively coupled, and which when programmed form the means for these system elements to implement their desired functionality, for example, as illustrated by reference to the methods and sequence diagrams shown in FIGS. 2-4.

The links 108, 112 are used for signaling or messaging (e.g., packets, datagrams, frames, superframes, or any other information blocks) between the PKI 102 and the certificate manager 110, as well as between the certificate manager 110 and the network devices 114. The implementation of the links 108, 112 depends on whether the connection between the elements is wired or wireless. For example, the interfaces between two elements within the communication system 100 can include one or more wired interfaces such as a serial port interface (e.g., compliant with the RS-232 standard), a parallel port interface, an Ethernet interface, a USB interface, and/or a FireWire interface, and the like. Where the interfaces support wireless communications, the interfaces comprise elements including processing, modulating, and transceiver elements (e.g., modems) and modems that are operable in accordance with any one or more standard or proprietary wireless interfaces, wherein some of the functionality of the processing, modulating, and transceiver elements may be performed by means of the processing device through programmed logic such as software applications or firmware stored on the memory device of the system element or through hardware.

The processing device utilized by the elements of communication system 100 may be programmed with software or firmware logic or code for performing functionality described by reference to FIGS. 2-4; and/or the processing device may be implemented in hardware, for example, as a state machine or ASIC (application specific integrated circuit). The memory implemented by these system elements can include short-term and/or long-term storage of information needed for the functioning of the respective elements. The memory may further store software or firmware for programming the processing device with the logic or code needed to perform its functionality.

Further, communication over the links 108, 112 can be over any broadband network such as an IP-based network, where the infrastructure elements within the network (not shown, e.g., IP routers, asynchronous transfer mode (ATM) switches, Multi-Protocol Label Switching (MPLS) switches, home agents, foreign agents, etc.) are IP compliant, for example based on RFC 791 (i.e. IPv4) or RFC 2460, and any subsequent versions. For example, in one illustrative implementation, communication over 108, 112 is accomplished via a 3GPP Long Term Evolution (LTE)-compliant network containing an LTE core and Radio Access Network (RAN). In other implementations, communication over 108, 112 is accomplished via a Worldwide Interoperability for IEEE 802.16 Microwave Access (WiMAX) core and RAN, a 3GPP2 EV-DO core and RAN, IEEE 802.11 based WiFi, digital subscriber line (DSL), an integrated service digital network (ISDN), a T-1 line, or a satellite connection, among others.

Communication over 108, 112 can optionally be accomplished via any narrowband network, for example via a gateway, such as a P25 network that includes infrastructure elements, e.g., base stations, base station controllers, and the like that are P25-compliant. Thus, the communication network 100 operates using a narrowband protocol such as the Common Air Interface (CAI) protocol or other narrowband protocols of a type well-known in the industry.

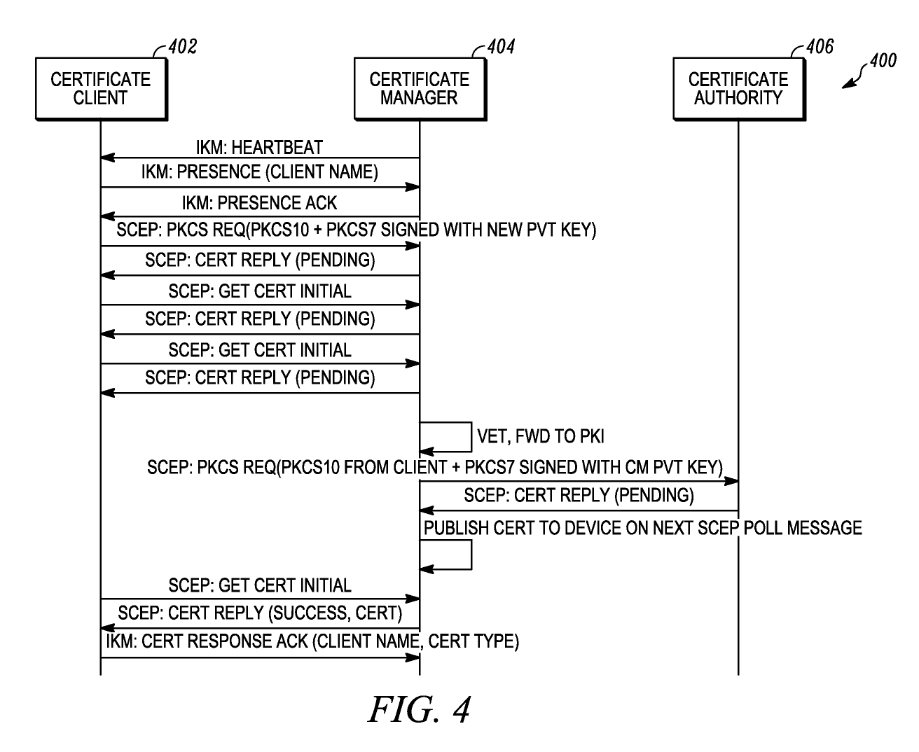

Turning now to the operation of the various elements of communication system 100 in accordance with the present disclosure, FIG. 2 shows a flow diagram illustrating a general method 200 for provisioning or managing device certificates, from the perspective of a certificate manager, in accordance with embodiments of the present disclosure. The functionality of method 200 is performed by a certificate manager (for example the certificate manager 110). Such functionality (as well as the functionality illustrated by way of the remaining FIGS. 3 and 4) is performed using the combination of a processing device, memory, and interface coupled together and adapted (through software, firmware, or hardware programming, for instance) to perform such functionality.

More particularly, at 202, the certificate manager 110 transmits a certificate service advertisement to a plurality of certificate clients (including, for example the certificate client 116 of the plurality of network devices 114). In various embodiments, the certificate service advertisement is transmitted to each of the plurality of certificate clients utilizing any suitable transmission type including, for example, unicast, broadcast or multicast, where the choice of transmission type depends on the configuration of the communication network 100, among others. When multicast is used as the transmission type for certificate service advertisements, the client typically joins the associated multicast group. This may include sending Internet Group Management Protocol (IGMP) (RFC 3376) packets or Multicast Listener Discovery (RFC 3810) packets to a local router. Generally, the certificate service advertisement is defined as an advertisement from the certificate manager 110 which indicates that PKI services are available through the certificate manager 110.

In some embodiments, prior to transmitting the certificate service advertisement, the certificate manager 110 detects an absence of other certificate managers operating within the communication network 100 using duplicate segregation data. In other embodiments, the certificate manager 110 detects other certificate managers operating within the communication network 100 that are transmitting a conflicting certificate service advertisement, wherein the conflicting certificate service advertisement uses duplicate or overlapping segregation data. If two or more certificate managers transmit certificate service advertisements with segregation data that indicates one or more common services, or one or more common sets of clients, the segregation data is said to be overlapping. Thus, in one illustrative embodiment, the certificate manager 110 automatically suppresses, from the certificate service advertisement, conflicting segregation data until the conflicting certificate service advertisement stops for a period of time as defined by some suitable threshold.

In the preferred embodiment, prior to any request for PKI services by the certificate client 116, the certificate client 116 indicates its presence to the certificate manager 110 by completion of a presence protocol for instance as described in RFCs 3920, 3921, 3922, and 3923, where the certificate manager 110 includes a presence server (not shown). Presence protocol messages received from the certificate client 116 can include, for example, a device type and a device name for network devices 114. Thus, via the presence protocol, the certificate manager 110 learns which network devices 114 and certificate clients are currently reachable within the communication network 100. Responsive to the presence messages received from the certificate client 116, the certificate manager 110 transmits an acknowledgement message to the certificate client 116. In an alternate embodiment the explicit presence indication and the presence protocol may be omitted. In such an embodiment other messages such as a CSRs, a SCEP Get_Certificate_Initial, or any other certificate management protocol message may be used to indicate the client's presence to the certificate manager.

The certificate service advertisement also includes identifying information for the certificate manger 110, as well as segregation data that indicates a set of services offered or a set of certificate clients for which the certificate manager 110 offers service. The segregation data includes, among others, one or more of: a Zone identifier (ID), a device ID, an internet protocol (IP) address space, IP address range, a link layer or media access control address space, a device type, a device name space, a required assurance level (e.g., amount of security required for a user), a list of supported applications, a supported certificate type, a device location within the communication network, parameters contained in an X.509 certificate, a list of supported certificate management protocols, time of day, geographic location, an object ID (as described in ITU-T recommendation X.208 (ASN.1), certificate policy, Trust Anchor ID, system name, site ID, Distinguished Name component, request type, other PKI parameters such as certificate lifecycle management (CLM) request type, CLM protocol, etc., or a string of numbers. In various embodiments, use of the segregation data allows for a plurality of certificate managers to operate simultaneously without conflicting with one another.

Further, the certificate service advertisement can include authentication data used by a client device to authenticate certificate manager and configuration data. For example, the configuration data includes one or more of: trust anchor certificates, a certificate management protocol type, an address or port for transmission of the certificate service request, a repository location, local certificate policy data used for standard certificate validation, certificate status methods, time synchronization data, certificate status caching rules, certificate rekey triggering data, or certificate renewal triggering data. A Trust Anchor is defined as a device's root of trust. The use or a Trust Anchor is further described in IETF RFC 5280 entitled “Internet X.509 Public Key Infrastructure Certificate and Certificate Revocation List (CRL) Profile”. The authentication data contained in a certificate service advertisement can include; a time stamp, a nonce, a signature, and message authentication code, and a certificate.

Upon successful completion of the presence protocol, the certificate manager 110 receives (204) a certificate service request from at least one certificate client, such as the certificate client 116, from the plurality of certificate clients. Among other functions, the certificate manager 110 performs a rogue client certificate service request detection before fulfilling the certificate service request, for example, to avoid a security breach by a unauthorized user and/or device. For example, the certificate manager detects anomalies, such as duplicate certificate signing requests having a different public key, highlights the affected devices, and populates an alarm list with the certificate signing request and or certificate that triggered the exception. As used herein, the term “certificate service request” is defined as any of several types of service requests including, for example, a certificate signing request, a certificate rekey request, or a certificate renew request. As used herein, the term “rekey” includes processes commonly known as “rekey”, “renewal” or certificate renewal. A certificate renewal is where a new certificate is issued with all of the information of an old certificate except that the expiration date is changed. A certificate rekey is where a new certificate is issued with all of the information of an old certificate except that the public key and the expiration date is changed. The certificate manager verifies (206) that the at least one certificate client is associated with the set of clients for which the certificate manager 110 offers service, and the certificate manager 110 fulfills (208) the certificate service request.

In one illustrative embodiment, if the certificate service request includes a certificate signing request (CSR) and upon verification by the certificate manager 110, the certificate manager 110 vets/approves the CSR and transmits the CSR to the CA 104. The CA 104 thus provides the signed certificate to the certificate manger 110, which fulfills the certificate client's CSR by providing the signed certificate to the certificate client 116.

Continuing with the CSR example above, the certificate manager 110 operates in a manual or automatic vetting mode. In the manual vetting mode, the certificate manager 110 displays, via a user interface coupled to the certificate manager 110, the CSRs received from each of the plurality of certificate clients including a state of each of the certificate clients that sent the CSRs. For example, the state includes a presence of a certificate and a validity of a certificate, among others. In the manual vetting mode, a user manually approves the CSRs, causing the certificate manager 110 to sign the CSRs and send them to the CA 104.

In the automatic vetting mode, in accordance with various embodiments, the certificate manager 110 includes a pre-defined list of rules for the communication network 100, which includes for example, a specified quantity and type of network devices and certificate clients. Thus, the certificate manager 110 knows how many CSRs, from each of a variety of network device types, it should receive. The certificate manager 110 waits until all are CSRs are received and verifies that there are no duplicates or errors, then automatically approves all the received CSRs and transmits them to the CA 104. Thus, in the automatic vetting mode, the certificate manager matches the counts of received CSRs of each device type with what is expected based on the pre-defined list of rules for the communication network 100, and transmits the CSRs to the CA 104. In an alternate embodiment of the automatic vetting mode, each individual CSR is automatically approved and transmitted to the CA 104 upon receipt by the certificate manager 110. Once all CSRs have been received, approved, and transmitted to the CA 104, the certificate manager 110 matches the counts of received CSRs of each device type with what is expected based on the pre-defined list of rules for the communication network 100. To facilitate these embodiments, a validate button may be provided for one click certificate validation, wherein the certificate manager validates all published certificates in a selected system when the button is pressed. An approval button may be further provided for one click certificate approval, wherein the certificate manager approves all CSRs in the selected system when the button is pressed.

Turning now to FIG. 3, this figure shows a flow diagram illustrating a general method 300 for provisioning or managing device certificates, from the perspective of a certificate client, in accordance with embodiments of the present disclosure. The functionality of method 300 is performed by a certificate client (for example the certificate client 116). Such functionality is performed using the combination of a processing device, memory, and interface coupled together and adapted (through software, firmware, or hardware programming, for instance) to perform such functionality.

More particularly, at 302, the certificate client 116 listens to a plurality of certificate service advertisements that correspond to a plurality of certificate managers, where each of the plurality of certificate service advertisements includes segregation data. In some embodiments, the presence of the plurality of certificate advertisements activates a certificate lifecycle management (CLM) state machine within the certificate client 116, wherein the certificate lifecycle management is a set of activities required to request, renew, or revoke certificates. The CLM state machine is suspended by a timer expiration due to a lack of certificate service advertisements. In other embodiments, the CLM state machine is driven by a presence or lack of appropriate certificate materials. For example, if the certificate client 116 powers up and determines that it is supposed to have certificates for a particular set of applications, but it is missing one or more certificates for this set of applications, then the certificate client 116 begins requesting the needed certificate(s), as long as its CLM state machine is active. In yet other embodiments, the CLM state machine is used to distinguish among different certificate managers, thus allowing the certificate client 116 to recover if an initial certificate manager leaves the communication network 100 and is replaced by another certificate manager.

As discussed above, use of segregation data allows for the plurality of certificate managers to operate simultaneously without conflicting with one another. For example, in a large network, the plurality of certificate managers can be used to partition the network in a variety of ways, such as partitioned geographically into a collection of nodes or “zones”, or partitioned based on device type, required assurance level, certificate policy, or type of certificate service request, to name a few.

The certificate client 116 identifies (304) one certificate manager from the plurality of certificate managers, where the one certificate manager's certificate service advertisement includes segregation data that corresponds to the certificate client 116. Moreover, the certificate client 116 uses authentication data to verify the authenticity of the identified one certificate manager. In one illustrative example, consider a communication network 100 including a first certificate manager and a second certificate manager, and consider that certificate client 116 is included within a network device such as a base station. Further, consider that the first certificate manager transmits a certificate service advertisement which includes segregation data that indicates that the first certificate manager is offering PKI services to base stations, while the second certificate manager transmits a certificate service advertisement which includes segregation data that indicates that the second certificate manager is offering PKI services to routers. Thus, the certificate client 116 identifies the first certificate manager as the one certificate manager having segregation data that corresponds to the certificate client 116.

Upon identifying the appropriate one certificate manager and completing the presence protocol, as described above, the certificate client 116 determines (306) if certificate services are required, and if so, the certificate client 116 transmits a certificate service request to the one certificate manager. In various embodiments, the certificate client 116 initiates certificate enrollment for each application of the network device that requires a certificate. The certificate client receives (308) a response for the certificate service request from the one certificate manager.

FIG. 4 illustrates a sequence diagram 400 for provisioning or managing device certificates, in accordance with various embodiments. The sequence diagram 400 illustrates messages used to perform an initial certificate signing request. However, there are other sequences of messages for certificate rekey, renew (for instance, when a certificate is about to expire), validate, and zeroize (e.g. delete certificate and associated credentials), as discussed below. As shown, a certificate manager 404 transmits a certificate service advertisement to a certificate client 402 via an Infrastructure Key Management (IKM) Heartbeat message. In various embodiments, the IKM: Heartbeat includes a periodic unicast, broadcast, or multicast message. Responsive to the IKM: Heartbeat, the certificate client 402 initiates the presence protocol by transmitting an IKM: Presence message to the certificate manager 404, where the IKM: Presence message includes a name of the certificate client 402, among others. Upon receipt of the IKM: Presence message, the certificate manager 404 transmits an IKM: Presence Acknowledgement message to the certificate client 402, thus establishing a relationship between the certificate manager 404 and the certificate client 402, where the certificate manager 404 and the certificate client 402 know that they can talk to each other.

As shown in the sequence diagram 400, many of the messages used to perform the initial certificate signing request include standard protocols, such as SCEP, or other standard protocols (not shown, e.g., CMP or CMC). Upon establishment of the relationship between the certificate manager 404 and the certificate client 402, the certificate client 402 initiates certificate requests/enrollment for each application that requires a certificate. In particular, the certificate client 402 accomplishes this by transmitting a SCEP public-key cryptography standard (PKCS) Request (SCEP: PKCS Req). As shown, the SCEP: PKCS Req includes a PKCS#10 message, as described, for example, in IETF RFC 2986, and a PKCS#7 message, as described, for example, in IETF RFC 2315, where the PKCS#7 message is signed with a new private key.

Responsive to the SCEP:PKCS Req, the certificate manager 404 transmits a SCEP: Cert Reply (Pending) message, and the certificate client 402 responds with a SCEP Poll message by transmitting a SCEP: Get Cert Initial message to the certificate manager 404. Communication between the certificate manager 404 and the certificate client 402 continues with the SCEP Poll message and the SCEP: Cert Reply (Pending) message.

Upon vetting/approval of the certificate requests by the certificate manager 404, the certificate manager transmits the SCEP: PKCS Req to a certificate authority 406, where the SCEP: PKCS Req is now signed with the certificate manager's 404 private key. Responsive to the SCEP: PKCS Req message received from the certificate manager 404, the certificate authority 406 provides the requested signed certificate by transmitting a SCEP: Cert Reply (Success, Cert) message, and the certificate is published to the certificate client 402 on a subsequent SCEP Poll message. Upon receipt of a SCEP: Get Cert Initial Poll message from the certificate client 402, the certificate manager 404 transmits the signed certificate to the certificate client 402 via a SCEP: Cert Reply (Success, Cert) message. The certificate client 402 responsively transmits an IKM: Cert Response Ack message, where the IKM: Cert Response Ack message includes the certificate client's 402 name and certificate type. The IKM: Cert Response Ack, as described herein, is used to verify, among others, that the certificates were properly issued to the requester.

As discussed above, there are other sequences of messages for certificate rekey, renew, validate, and zeroize. For example, in some embodiments, the certificate manager 404 requests certificate validation via an IKM: Validate message transmitted to a set of selected certificate clients, such as the certificate client 402, where the certificate client 402 responds with an IKM: Cert Response Ack (client name, cert type) message transmitted to the certificate manager 404. In other embodiments, the certificate manager 404 requests to zeroize certificates, rekey certificates, or renew certificates by transmitting an IKM: Zeroize message to a set of selected certificate clients, an IKM: Rekey message to a set of selected certificate clients, or an IKM: Renew message to a set of selected certificate clients, respectively. The set of selected certificate clients includes, for example, the certificate client 402. The certificate client 402 acknowledges each of the IKM: Zeroize message, the IKM: Rekey message, or the IKM: Renew message, for example, with a new certificate signing request. Illustratively, responsive to receipt of a rekey request, the certificate client 402 transmits a new certificate service request for each specified certificate type. In another illustrative example, responsive to receipt of a zeroize request, the certificate client 402 deletes existing certificates and keys corresponding to specified certificate types, and transmits a new certificate service request for a new certificate. Also, responsive to receipt of a certificate validation request for a specified set of certificate types, the certificate client 402 transmits a certificate corresponding to each specified certificate type.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for provisioning or managing device certificates in a communication network, the method comprising:
at a certificate manager:
transmitting a certificate service advertisement to a plurality of certificate clients, wherein the certificate service advertisement identifies the certificate manager, and wherein the certificate service advertisement includes segregation data that indicates a set of services offered or a set of clients for which the certificate manager offers service;
responsive to the transmitting, receiving a certificate service request from at least one certificate client of the plurality of certificate clients;
verifying that the at least one certificate client is associated with the set of clients for which the certificate manager offers service; and
fulfilling the certificate service request.

2. The method of claim 1 further comprising:
performing a rogue client certificate service request detection before fulfilling the certificate service request.

3. The method of claim 1 wherein the certificate service advertisement further includes configuration data for the plurality of certificate clients.

4. The method of claim 3 wherein the configuration data includes at least one of: trust anchor certificates, a certificate management protocol type, an address or port for transmission of the certificate service request, a repository location, local certificate policy data used for standard certificate validation, certificate status methods, time synchronization data, certificate status caching rules, certificate rekey triggering data, or certificate renewal triggering data.

5. The method of claim 1 further comprising:
receiving a presence message from the at least one certificate client that indicates the certificate client's presence to the certificate manager;
transmitting an acknowledgement message in response to the presence message received from the at least one certificate client.

6. The method of claim 1 wherein the segregation data includes at least one of: an internet protocol (IP) address space, a device type, a device name space, a required assurance level, a list of supported applications, a supported certificate type, a device location within the communication network, parameters contained in an X.509 certificate, or a list of supported certificate management protocols.

7. The method of claim 1 wherein the certificate service advertisement further includes authentication data for authenticating the certificate manager.

8. The method of claim 1 further comprising:
transmitting a rekey message to a set of selected certificate clients for a specified set of certificate types.

9. The method of claim 1 further comprising:
transmitting a zeroize message to a set of selected certificate clients for a specified set of certificate types.

10. The method of claim 1 further comprising:
transmitting a certificate validation request to a set of selected certificate clients for a specified set of certificate types.

11. The method of claim 1 further comprising:
detecting, prior to transmitting the certificate service advertisement, an absence of other certificate managers operating within the communication network using duplicate segregation data.

12. The method of claim 1 further comprising:
detecting other certificate managers operating within the communication network that are transmitting a conflicting certificate service advertisement, wherein the conflicting certificate service advertisement uses duplicate segregation data; and
automatically suppressing, from the certificate service advertisement, conflicting segregation data until the conflicting certificate service advertisement stops for a period of time.

13. A method for provisioning and managing certificates in a communication network, the method comprising:
at a certificate client:
listening to a plurality of certificate service advertisements that correspond to a plurality of certificate managers, wherein each of the plurality of certificate service advertisements includes segregation data;
identifying one certificate manager from the plurality of certificate managers, wherein the segregation data of the one certificate manager's certificate service advertisement that corresponds to the certificate client;
responsive to the identifying, determining if certificate services are required;
when certificate services are required, transmitting a certificate service request to the one certificate manager; and
receiving a response for the certificate service request.

14. The method of claim 13 further comprising:
sending a presence message to the identified one certificate manager in response to a certificate service advertisement of the plurality of certificate service advertisements.

15. The method of claim 13, wherein the certificate service advertisement further includes authentication data, the method further comprising:
using the authentication data to verify the authenticity of the identified one certificate manager.

16. The method of claim 13 further comprising:
Receiving, from the certificate manager, a rekey request for a set of specified certificate types;
responsive to receipt of the rekey request, transmitting a new certificate service request for each specified certificate type.

17. The method of claim 13 further comprising:
responsive to receipt of a zeroize request, deleting existing certificates and keys corresponding to specified certificate types; and
transmitting a new certificate service request for a new certificate.

18. The method of claim 13 further comprising:
receiving, from the certificate manager, a certificate validation request for a specified set of certificate types;
responsive to receipt of the certificate validation request, transmitting a certificate corresponding to each specified certificate type.

19. The method of claim 13 further comprising:
responsive to listening to the plurality of certificate service advertisements, activating a certificate lifecycle management state machine.

20. The method of claim 19 further comprising:
suspending the certificate lifecycle management state machine by a timer expiration due to a lack of certificate service advertisements.
